(19) United States
(12) Patent Application Publication
(10) Pub. No.: US 2023/0371090 A1
(43) Pub. Date: Nov. 16, 2023

(54) METHOD, DEVICE AND COMPUTER READABLE MEDIUM FOR COMMUNICATIONS

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 18/029,305

(22) PCT Filed: Sep. 30, 2020
(86) PCT No.: PCT/CN2020/119524

§ 371 Date: Mar. 29, 2023

(51) Int. Cl. H04W 76/14; H04W 72/02

(52) U.S. Cl. CPC H04W 76/14; H04W 72/02

(57) ABSTRACT

Embodiments of the present disclosure relate to a method, device and computer readable media for communications. A method comprises selecting, at a first terminal device, at least one candidate resource in a resource selection window. The method further comprises receiving, from a second terminal device, coordination information for resource selection for a sidelink transmission of the first terminal device. The method further comprises selecting a first set of target resources for the sidelink transmission in the resource selection window based on at least one of the coordination information and the at least one candidate resource.

### TECHNICAL FIELD

Embodiments of the present disclosure generally relate to the field of telecommunication, and in particular, to a method, device and computer readable medium for resource selection.

### BACKGROUND

Certain communication systems enable vehicle to everything (V2X) and device to device (D2D) communications to be performed. V2X communications can be based on communication technologies such as sidelink communication technologies. For this purpose, sidelink resource pools and sidelink channels may be established for vehicles participating in such communications.

In V2X communications, there are two modes of resource allocation. In a first mode (also referred to as NR V2X mode 1 or mode 1 hereinafter), a terminal device may use a resource allocated by a network device for a sidelink transmission. In a second mode (also referred to as NR V2X mode 2 or mode 2 hereinafter), the terminal device may use a resource autonomously selected in a resource pool by the terminal device for the sidelink transmission.

In the mode 2, after selecting at least one candidate resource, the terminal device may receive from a further terminal device coordination information for selection of target resources for the sidelink transmission. But the coordination information has not been well used.

### SUMMARY

In general, example embodiments of the present disclosure provide a method, device and computer readable medium for communications.

In a first aspect, there is provided a method for communications. The method comprises selecting, at a first terminal device, at least one candidate resource in a resource selection window. The method further comprises receiving, from a second terminal device, coordination information for resource selection for a sidelink transmission of the first terminal device. The method further comprises selecting a first set of target resources for the sidelink transmission in the resource selection window based on at least one of the coordination information and the at least one candidate resource.

In a second aspect, there is provided a terminal device. The terminal device comprises a processor and a memory storing instructions. The memory and the instructions are configured, with the processor, to cause the terminal device to perform the method according to the first aspect.

In a third aspect, there is provided a computer readable medium having instructions stored thereon. The instructions, when executed on at least one processor of a device, cause the device to perform the method according to the first aspect.

In a fourth aspect, there is provided a method for communications. The method comprises selecting, at a first terminal device, at least one candidate resource in a resource selection window. The method further comprises receiving, from a second terminal device, information for resource selection for a sidelink transmission of the first terminal device. The method further comprises determining at least one target resource for the sidelink transmission in the resource selection window based on at least one of the information and the at least one candidate resource.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example signaling chart showing an example process for resource selection in accordance with some embodiments of the present disclosure;

FIG. 3 illustrates a schematic diagram showing an example process for resource selection in accordance with some embodiments of the present disclosure;

FIGS. 4A-4F illustrate schematic diagrams showing example processes for resource selection in accordance with some other embodiments of the present disclosure, respectively;

FIGS. 5A and 5B illustrate schematic diagrams showing example processes for resource selection in accordance with still other embodiments of the present disclosure, respectively;

FIG. 6 illustrates a schematic diagram showing an example process for resource selection in accordance with still other embodiments of the present disclosure;

FIG. 7 illustrates a flowchart of an example method in accordance with some embodiments of the present disclosure;

FIG. 8 illustrates a flowchart of an example method in accordance with some other embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As described above, in V2X communications, in the mode 2 of resource allocation, after selecting at least one candidate resource, the terminal device may receive from a further terminal device coordination information for selection of target resources for the sidelink transmission. The behaviors of the terminal device upon receiving the coordination information need to be studied.

Embodiments of the present disclosure provide a solution for resource selection in V2X communications, so as to solve the above problems and one or more of other potential problems. According to the solution, after selecting at least one candidate resource in a resource selection window, a first terminal device receives, from a second terminal device, coordination information for resource selection for a sidelink transmission of the first terminal device. In turn, the first terminal device selects a first set of target resources for the sidelink transmission in the resource selection window based on at least one of the coordination information and the at least one candidate resource. In this way, coordination for resource selection between the first terminal device and the second terminal device is enabled.

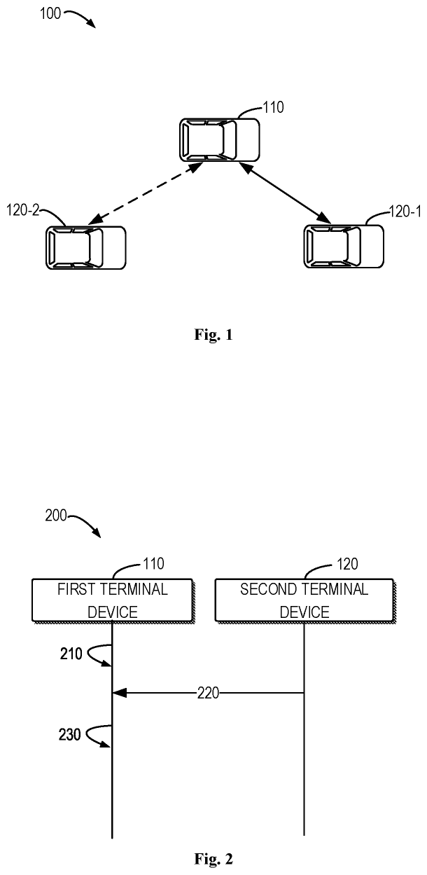

FIG. 1 illustrates a schematic diagram of an example communication network 100 in which embodiments of the present disclosure can be implemented. As shown in FIG. 1, the communication network 100 may include a terminal device 110 (also referred to as “first terminal device 110”), and terminal devices 120-1 and 120-2 (collectively referred to as “second terminal devices 120” or individually referred to as “second terminal device 120”). It should be understood that the communication network 100 may further include a network device (not shown). The network device may communicate with the first terminal device 110 and the second terminal devices 120 via respective wireless communication channels. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

In FIG. 1, the first terminal device 110 and the second terminal devices 120 are shown as vehicles which enable V2X communications. It is to be understood that embodiments of the present disclosure are also applicable to other terminal devices than vehicles, such as mobile phones, sensors and so on.

In some embodiments, the first terminal device 110 may have established a sidelink with the terminal device 120-1. In other words, the first terminal device 110 may have established an on-going communication session with the terminal device 120-1. In this regard, the terminal device 120-1 may be referred to as an in-session terminal device.

In other embodiments, the first terminal device 110 may not have established a sidelink with the terminal device 120-2. In other words, the first terminal device 110 may not have established an on-going communication session with the terminal device 120-1. In this regard, the terminal device 120-1 may be referred to as an out-of-session terminal device.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

FIG. 2 illustrates an example signaling chart showing an example process 200 for resource selection in accordance with some embodiments of the present disclosure. As shown in FIG. 2, the process 200 may involve the first terminal device 110 and the second terminal devices 120 as shown in FIG. 1. It is to be understood that the process 200 may include additional acts not shown and/or may omit some acts as shown, and the scope of the present disclosure is not limited in this regard. In addition, it will be appreciated that, although primarily presented herein as being performed serially, at least a portion of the acts of the process 200 may be performed contemporaneously or in a different order than as presented in FIG. 2.

As shown in FIG. 2, the first terminal device 110 selects (210) at least one candidate resource in a resource selection window. The first terminal device 110 receives (220), from the second terminal device 120, coordination information for resource selection for a sidelink transmission of the first terminal device 110. The first terminal device 110 selects (230) a first set of target resources for the sidelink transmission in the resource selection window based on at least one of the coordination information and the at least one candidate resource. In this way, coordination for resource selection between the first terminal device 110 and the second terminal device 120 is enabled.

In some example embodiments, the coordination information may comprise information about a set of resources. The set of resources may comprise a single resource or a plurality of resources. Alternatively, the set of resources may comprise one-shot resource. Features of the single resource that will be described hereinafter are also applicable to the one-shot resource.

In some example embodiments, the information about the set of resources may comprise at least one of time domain location information of the resources and frequency domain location information of the resources.

For example, in case where the set of resources comprises a plurality of resources, time domain location information may comprise at least one of the following: number of resources, starting slot index, or periodicity of the multiple resources. The frequency domain location information may comprise at least one of the following: PRB index of the boundary of the resources or frequency length of the resources. For example, the PRB index of the boundary of the resources may indicate a low end or a high end of the resources. The frequency length of the resources may indicate the PRB number or Subchannel number of the resources.

In some example embodiments, the first terminal device 110 may receive the coordination information on one of the following: Physical Sidelink Shared Channel (PSSCH), Sidelink Control Information (SCI), Physical Sidelink Feedback Channel (PSFCH) and a PC5 radio resource control (RRC) message. In case where the first terminal device 110 receives the coordination information on the PSSCH, the first terminal device 110 receives the coordination information in a Media Access Control (MAC) message.

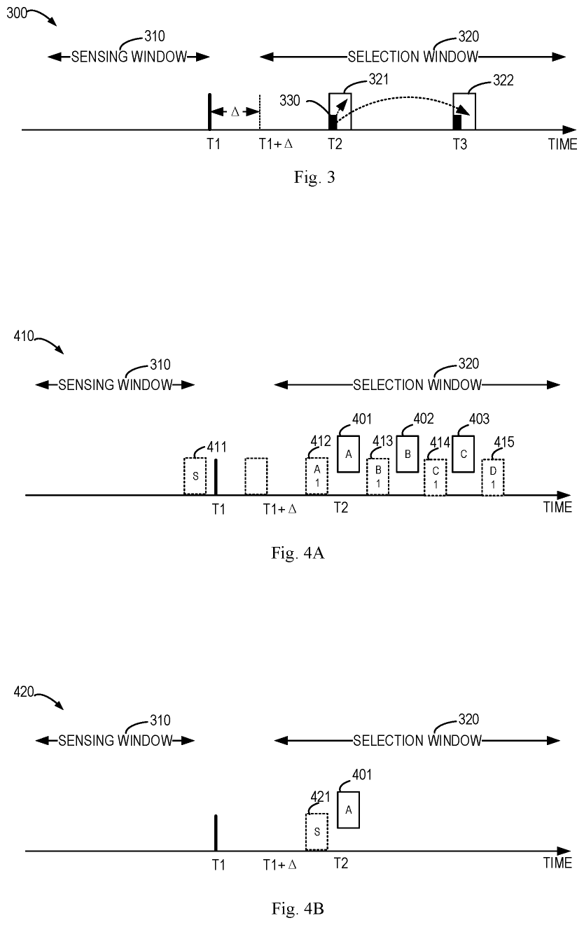

In some example embodiments, the first terminal device 110 may receive the coordination information after selecting the at least one candidate resource and before transmitting a resource reservation signaling indicating the at least one candidate resource. This will be described with reference to FIG. 3.

FIG. 3 illustrates a schematic diagram showing an example process 300 for resource selection in accordance with some embodiments of the present disclosure. For the purpose of discussion, the example process 300 will be described with reference to FIG. 1. However, it would be appreciated that the example process 300 may be equally applicable to other communication scenarios where a terminal device and a further terminal device communicate with each other.

In the example process 300, at time T1, a physical layer of the terminal device 110 may receive from a higher layer of the terminal device 110 a trigger for resource selection for a sidelink transmission of the first terminal device 110. Then, the first terminal device 110 performs sensing of sidelink channels in a sensing window 310.

Through sensing of sidelink channels in the sensing window 310, the physical layer of the first terminal device 110 excludes from a resource selection window 320 one or more candidate resources that are identified as occupied by other terminal devices. For example, the other terminal devices may comprise the second terminal device 120 and/or one or more terminal devices not shown in FIG. 1.

In turn, the physical layer of the first terminal device 110 reports to the higher layer the candidate single-slot resources remaining in the resource selection window 320 as the results of sensing.

At time T1+Δ, the first terminal device 110 selects candidate resources 321 and 322 in the resource selection window 320 for sidelink transmission. Hereinafter, the candidate resources may be also referred to as pre-selected resources.

It will be understood that although the candidate resources 321 and 322 are shown to be selected in the example process 300, more or less candidate resources may be selected in other examples. The scope of the present disclosure is not limited thereto.

At time T2, the first terminal device 110 transmits a resource reservation signaling 330 indicating the candidate resources 321 and 322. For example, the first terminal device 110 may transmit the resource reservation signaling 330 on Physical Sidelink Control Channel (PSCCH). In some example embodiments, the first terminal device 110 may transmit the resource reservation signaling 330 to the terminal devices 120-1 and 120-2. Of course, the first terminal device 110 may also transmit the resource reservation signaling 330 to other terminal devices not shown in FIG. 1.

In some example embodiments, after selecting the candidate resources 321 and 322 and before transmitting the resource reservation signaling 330, that is, during the time interval [T1+Δ, T2], the first terminal device 110 may receive, from the second terminal device 120, coordination information for resource selection for a sidelink transmission of the first terminal device 110.

Upon receiving the coordination information, the first terminal device 110 selects the first set of target resources for the sidelink transmission in the resource selection window 320 based on at least one of the coordination information and the at least one candidate resource.

In some example embodiments, the coordination information may comprise first information about a first single resource that is suggested to be selected by the first terminal device 110 for the sidelink transmission. In such example embodiments, the first terminal device 110 may receive the coordination information on a resource subsequent to the first single resource in time domain. For example, in case where the resource is a single-slot resource, an index of a slot where the first single resource is located may be less than that of a slot where the resource is located.

In such example embodiments, the first terminal device 110 may determine whether the sidelink transmission comprises transmissions of periodic traffic or a transmission of aperiodic traffic. For example, if a resource reservation interval selected from a Radio Resource Control (RRC) parameter sl-ResourceReservePeriodList equals 0, the first terminal device 110 determines that the sidelink transmission comprises the transmission of aperiodic traffic. Otherwise, if a resource reservation interval selected from a Radio Resource Control (RRC) parameter sl-ResourceReservePeriodList equals a non-zero value, the first terminal device 110 determines that the sidelink transmission comprises the transmissions of periodic traffic.

If the first terminal device 110 determines that the sidelink transmission comprises the transmission of aperiodic traffic, the first terminal device 110 may not handle the coordination information and deliver the candidate resources 321 and 322 to the physical layer of the first terminal device 110 as a sidelink (SL) grant.

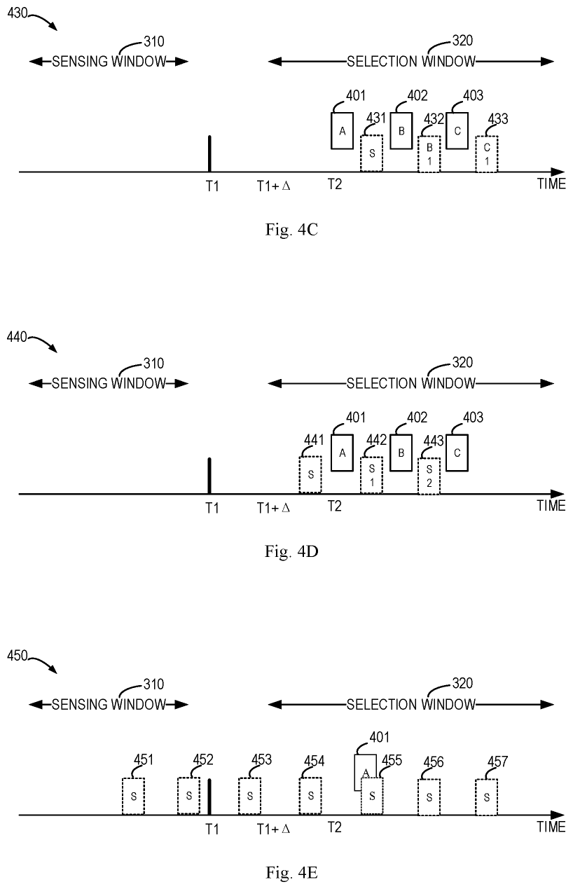

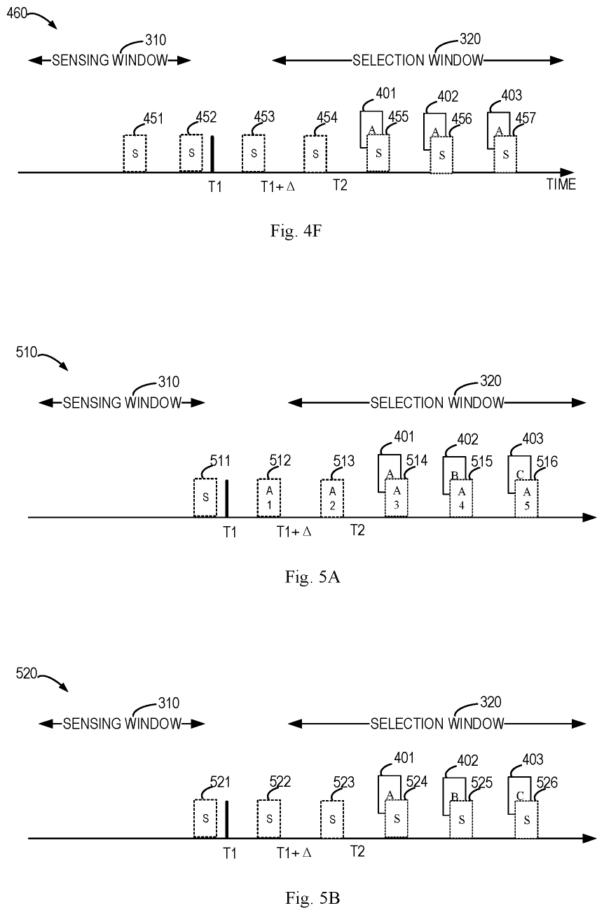

On the other hand, if the first terminal device 110 determines that the sidelink transmission comprises the transmissions of periodic traffic, the first terminal device 110 determines a second set of available resources in the resource selection window based on the first information and a periodicity of the periodic traffic. In some example embodiments, the first terminal device 110 may determine the periodicity of the periodic traffic based on a resource reservation interval selected from RRC parameter sl-ResourceReservePeriodList. Hereinafter, the resource reservation interval will be represented by P_rsrv ms. Upon determining the second set of available resources, the first terminal device 110 selects the first set of target resources based on the second set of available resources. This will be described with reference to FIG. 4A.

FIG. 4A illustrates a schematic diagram showing an example process 410 for resource selection in accordance with some embodiments of the present disclosure. For the purpose of discussion, the example process 410 will be described with reference to FIGS. 1 and 3. However, it would be appreciated that the example process 410 may be equally applicable to other communication scenarios where a terminal device and a further terminal device communicate with each other.

In the example process 410, the sidelink transmission of the first terminal device 110 comprises transmissions of periodic traffic. At time T1+Δ, the first terminal device 110 selects candidate resources 401, 402 and 403 in the resource selection window 320 for the sidelink transmission. During the time interval [T1+Δ, T2], the first terminal device 110 receives, from the second terminal device 120, coordination information for resource selection for the sidelink transmission. The coordination information comprises information about a past resource 411 that is suggested to be selected by the first terminal device 110 for the sidelink transmission.

Based on the information about the past resource 411 and a periodicity of the periodic traffic, the first terminal device 110 may determine a second set of available resources in the resource selection window 320. For example, based on the resource reservation interval P_rsrv ms and an index of a slot where the resource 411 is located, the first terminal device 110 may determine indexes of slots where the available resources in the second set. Specifically, the first terminal device 110 may determine indexes of slots where the available resources in the second set based on a sum of the index of the slot where the resource 411 is located and one or multiple P_rsrv ms.

In the example process 410, the second set of available resources comprises resources 412, 413, 414 and 415. In turn, the first terminal device 110 selects the first set of target resources based on the resources 412, 413, 414 and 415.

In some example embodiments, the first terminal device 110 may select the first set of target resources by iteratively performing the following until a first number of the target resources in the first set is equal to a first predetermined number. The first terminal device 110 may select a starting target resource in the first set based on a first available resource in the second set, update the starting target resource with a target resource subsequent to the starting target resource in the first set, and update the first available resource with an available resource subsequent to the first available resource in the second set.

In some example embodiments, the first available resource in the second set may comprise a starting available resource in the second set. For example, in the example process 410, the starting available resource in the second set is the resource 412. Thus, the first terminal device 110 may select the starting target resource in the first set based on the resource 412 in the second set. For example, in case where the coordination information comprises time domain location information and frequency domain location information of the resource 411, the first terminal device 110 may determine time domain location information and frequency domain location information of the resources 412 to 415. In this case, the first terminal device 110 may select the resource 412 as the starting target resource.

In other example embodiments, the first available resource in the second set may comprise an available resource (also referred to as a second available resource) in the second set that is subsequent to the starting target resource in time domain. For example, in the example process 410, the second available resource in the second set that is subsequent to the starting target resource is the resource 413. Thus, the first terminal device 110 may select the starting target resource based on the resource 413.

In still other example embodiments, the first terminal device 110 may select the starting target resource based on an available resource in the second set that is nearest to the starting target resource in time domain. In such example embodiments, the first available resource in the second set may comprise an available resource (also referred to as a third available resource) in the second set, and a timing value between the third available resource and a starting candidate resource is equal to a first threshold timing value.

In some example embodiments, the first threshold timing value may be determined as a minimum timing value among the starting candidate resource and the available resources in the second set. For example, in the example process 410, the first terminal device 110 may determine timing values among the starting candidate resource 401 and the resources 412 to 415 in the second set. Further, the first terminal device 110 may determine a minimum timing value among the timing values. For example, a timing value between the resource 413 and the starting candidate resource 401 may be the minimum timing value. Thus, the first terminal device 110 may determine the timing value between the resource 413 and the starting candidate resource 401 as the first threshold timing value. In turn, the first terminal device 110 may select the starting target resource based on the resource 413.

Upon selecting the starting target resource, in order to select one or more target resources subsequent to the starting target resource, the first terminal device 110 may update the starting target resource with a target resource subsequent to the starting target resource in the first set, and update the first available resource with an available resource subsequent to the first available resource in the second se.

For example, in the example process 410, in case where the first available resource comprises the resource 412, the first terminal device 110 may update the first available resource with the available resource 413. In this way, the first terminal device 110 may select a target resource subsequent to the starting target resource based on the available resource 413. For example, the first terminal device 110 may select the resource 413 as the target resource subsequent to the starting target resource. Similarly, the first terminal device 110 may select the resource 414 as a further target resource subsequent to the target resource.

The first terminal device 110 may iteratively perform the above actions until a first number of the target resources in the first set is equal to a first predetermined number. In some example embodiments, the first predetermined number may be equal to the number of the at least one candidate resource. For example, in the example process 410, the first predetermined number may be equal to three.

In example embodiments where the coordination information may comprise the first information about the first single resource that is suggested to be selected by the first terminal device 110 for the sidelink transmission, the first terminal device 110 may receive the coordination information on a resource prior to the first single resource in time domain. For example, in case where the resource is a single-slot resource, an index of a slot where the first single resource is located may be greater than that of a slot where the resource is located. In this case, the first single resource may be referred to as a future resource.

In such example embodiments, if the first terminal device 110 determines that the sidelink transmission comprises the transmission of aperiodic traffic, the first terminal device 110 may determine the second set of the available resources includes the first single resource. In turn, the first terminal device 110 selects the first set of the target resources based on the first single resource. This will be described with reference to FIG. 4B.

FIG. 4B illustrates a schematic diagram showing an example process 420 for resource selection in accordance with some embodiments of the present disclosure. For the purpose of discussion, the example process 420 will be described with reference to FIGS. 1 and 3. However, it would be appreciated that the example process 420 may be equally applicable to other communication scenarios where a terminal device and a further terminal device communicate with each other.

In the example process 420, the sidelink transmission of the first terminal device 110 comprises a transmission of aperiodic traffic. At time T1+Δ, the first terminal device 110 selects the candidate resource 401 in the resource selection window 320 for the sidelink transmission. During the time interval [T1+Δ, T2], the first terminal device 110 receives, from the second terminal device 120, coordination information for resource selection for the sidelink transmission. The coordination information comprises information about a future resource 421 that is suggested to be selected by the first terminal device 110 for the sidelink transmission.

In example process 420, the first set of the target resources comprises a single target resource. Upon receiving the coordination information, the first terminal device 110 selects the single target resource based on the future resource 421. For example, the first terminal device 110 may select the future resource 421 as the single target resource. Upon selecting the single target resource, the first terminal device 110 delivers the single target resource to the physical layer as an SL grant.

In example embodiments where the coordination information may comprise the first information about the single future resource that is suggested to be selected and the first terminal device 110 receives the coordination information on the resource prior to the first single resource in time domain, if the first terminal device 110 determines that the sidelink transmission comprises the transmissions of periodic traffic, the first terminal device 110 may determine the second set of the available resources includes the first single resource based on the first information and the periodicity of the periodic traffic. In turn, the first terminal device 110 selects the first set of the target resources based on the second set. This will be described with reference to FIG. 4C.

FIG. 4C illustrates a schematic diagram showing an example process 430 for resource selection in accordance with some embodiments of the present disclosure. For the purpose of discussion, the example process 430 will be described with reference to FIGS. 1 and 3. However, it would be appreciated that the example process 430 may be equally applicable to other communication scenarios where a terminal device and a further terminal device communicate with each other.

In the example process 430, the sidelink transmission of the first terminal device 110 comprises transmissions of periodic traffic. At time T1+Δ, the first terminal device 110 selects the candidate resources 401, 402 and 403 in the resource selection window 320 for the sidelink transmission. During the time interval [T1+Δ, T2], the first terminal device 110 receives, from the second terminal device 120, coordination information for resource selection for the sidelink transmission. The coordination information comprises information about a future resource 431 that is suggested to be selected by the first terminal device 110 for the sidelink transmission.

Upon receiving the coordination information, based on the first information and the periodicity of the periodic traffic, the first terminal device 110 determines the second set of the available resources that includes resources 431, 432 and 433. In turn, the first terminal device 110 selects the first set of target resources based on the resources 431, 432 and 433. For example, the first terminal device 110 may select the resources 431, 432 and 433 as the target resources in the first set.

In some example embodiments, the coordination information comprises second information about a third set of resources that are suggested to be selected by the first terminal device 110 for the sidelink transmission. The third set comprises a plurality of resources.

In such embodiments, the first terminal device 110 may receive the coordination information on a resource prior to a starting resource in the third set in time domain.

In such embodiments, if the first terminal device 110 determines that the sidelink transmission comprises transmissions of periodic traffic, the first terminal device 110 determines whether a periodicity of the plurality of resources in the third set is equal to a periodicity of the periodic traffic. If the periodicity of the plurality of resources in the third set is equal to the periodicity of the periodic traffic, the first terminal device 110 selects the first set of target resources based on the third set. This will be described with reference to FIG. 4D.

FIG. 4D illustrates a schematic diagram showing an example process 440 for resource selection in accordance with some embodiments of the present disclosure. For the purpose of discussion, the example process 440 will be described with reference to FIGS. 1 and 3. However, it would be appreciated that the example process 440 may be equally applicable to other communication scenarios where a terminal device and a further terminal device communicate with each other.

Different from the example process 420, in the example process 440, the coordination information comprises information about a third set of resources that are suggested to be selected by the first terminal device 110 for the sidelink transmission. The third set comprises resources 441, 442 and 443.

Upon receiving the coordination information, the first terminal device 110 determines whether a periodicity of the resources 441, 442 and 443 is equal to the periodicity of the periodic traffic. If the periodicity of the resources 441, 442 and 443 is equal to the periodicity of the periodic traffic, the first terminal device 110 selects the first set of target resources based on the resources 441, 442 and 443. If the periodicity of the resources 441, 442 and 443 is not equal to the periodicity of the periodic traffic, the first terminal device 110 may not handle the resources 441, 442 and 443.

In some example embodiments, the first terminal device 110 may receive the coordination information on a resource subsequent to a starting resource in the third set in time domain and a subset of the third set is in the resource selection window. In other words, the coordination information comprises information about both at least one past resource and at least one future resource.

In such example embodiments, if the first terminal device 110 determines that the sidelink transmission comprises transmission of aperiodic traffic, the first terminal device 110 may select the first set of target resources based on a fourth resource in the subset. The fourth resource in the subset comprises at least one of the following: a starting resource in the subset, a fifth resource in the subset that is subsequent to a starting target resource in the first set in time domain, or a sixth resource in the subset. A timing value between the sixth resource and a starting candidate resource is equal to a second threshold timing value. This will be described with reference to FIG. 4E.

FIG. 4E illustrates a schematic diagram showing an example process 450 for resource selection in accordance with some embodiments of the present disclosure. For the purpose of discussion, the example process 450 will be described with reference to FIGS. 1 and 3. However, it would be appreciated that the example process 450 may be equally applicable to other communication scenarios where a terminal device and a further terminal device communicate with each other.

In the example process 450, the sidelink transmission of the first terminal device 110 comprises transmission of aperiodic traffic. At time T1+Δ, the first terminal device 110 selects candidate resource 401 in the resource selection window 320 for the sidelink transmission. During the time interval [T1+Δ, T2], the first terminal device 110 receives, from the second terminal device 120, coordination information for resource selection for the sidelink transmission. The coordination information comprises information about past resources 451, 452, 453 and future resources 454, 455, 456, 457 that are suggested to be selected by the first terminal device 110 for the sidelink transmission.

Based on the information about the past resources 451, 452, 453 and future resources 454, 455, 456, 457 as well as a periodicity of the periodic traffic, the first terminal device 110 may determine a subset of the third set in the resource selection window 320. The subset comprises the resources 454, 455, 456, 457. In turn, the first terminal device 110 may select the first set of target resources based on a fourth resource in the subset. For example, the fourth resource may be the resource 454 that is a starting resource in the subset. For another example, the fourth resource may be the resource 455 that is subsequent to the starting candidate resource 401. For yet another example, the fourth resource may be the resource 455 that is the nearest to the starting candidate resource 401.

In example embodiments where the coordination information comprises information about both at least one past resource and at least one future resource, if the first terminal device 110 determines that the sidelink transmission comprises transmissions of periodic traffic, the first terminal device 110 may select the first set of target resources by iteratively performing the following until a second number of the target resources in the first set is equal to a second predetermined number. The first terminal device 110 may select a starting target resource in the first set based on a seventh resource in the subset, update the starting target resource with a target resource subsequent to the starting target resource in the first set, and update the seventh resource with a resource subsequent to the seventh available resource in the subset. This will be described with reference to FIG. 4F.

FIG. 4F illustrates a schematic diagram showing an example process 460 for resource selection in accordance with some embodiments of the present disclosure. For the purpose of discussion, the example process 460 will be described with reference to FIGS. 1 and 3. However, it would be appreciated that the example process 460 may be equally applicable to other communication scenarios where a terminal device and a further terminal device communicate with each other.

In the example process 460, the sidelink transmission of the first terminal device 110 comprises transmissions of periodic traffic. Different from the example process 450, at time T1+Δ, the first terminal device 110 selects the candidate resources 401, 402 and 403 in the resource selection window 320 for the sidelink transmission.

In order to select the first set, the first terminal device 110 selects a starting target resource in the first set based on a seventh resource in the subset. For example, the seventh resource may be the resource 454 that is a starting resource in the subset. For another example, the seventh resource may be the resource 455 that is subsequent to the starting candidate resource 401. For yet another example, the seventh resource may be the resource 455 that is the nearest to the starting candidate resource 401.

Similar to the example process 410, upon selecting the starting target resource, in order to select one or more target resources subsequent to the starting target resource, the first terminal device 110 updates the starting target resource with a target resource subsequent to the starting target resource in the first set and updates the seventh resource with a resource subsequent to the seventh resource in the subset.

In some example embodiments, the coordination information comprises third information about a fourth set of resources that are not suggested to be selected by the first terminal device 110 for the sidelink transmission.

In such example embodiments, the first terminal device 110 may identify an overlap between the at least one candidate resource and the fourth set and determine a subset of the fourth set that comprises the overlap. In turn, the first terminal device 110 may select the first set based on the subset. On the other hand, if there is no overlap between the at least one candidate resource and the fourth set, the first terminal device 110 may not handle the fourth set. This will be described with reference to FIGS. 5A and 5B.

FIG. 5A illustrates a schematic diagram showing an example process 510 for resource selection in accordance with some embodiments of the present disclosure. For the purpose of discussion, the example process 510 will be described with reference to FIGS. 1 and 3. However, it would be appreciated that the example process 510 may be equally applicable to other communication scenarios where a terminal device and a further terminal device communicate with each other.

In the example process 510, the sidelink transmission of the first terminal device 110 comprises transmission of periodic traffic. At time T1+Δ, the first terminal device 110 selects the candidate resources 401, 402 and 403 in the resource selection window 320 for the sidelink transmission. During the time interval [T1+Δ, T2], the first terminal device 110 receives, from the second terminal device 120, coordination information for resource selection for the sidelink transmission. The coordination information comprises information about the fourth set that is not suggested to be selected by the first terminal device 110 for the sidelink transmission. In this case, the fourth set comprises a past resource 511.

Based on the information about the past resource 511 and a periodicity of the periodic traffic, the first terminal device 110 may determine a fifth set of resources in the resource selection window 320. The fifth set is not suggested to be selected by the first terminal device 110 for the sidelink transmission. In the example process 510, the fifth set comprises resources 511, 512, 513, 514, 515 and 516. In turn, the first terminal device 110 identifies an overlap between the candidate resources 401, 402 and 403 and the resources 511, 512, 513, 514, 515 and 516 and determines a subset of the fifth set that comprises the overlap. Because there is overlap between the candidate resources 401, 402 and 403 and the resources 513, 514 and 515, the subset of the fifth set comprises the resources 513, 514 and 515. In turn, the first terminal device 110 selects the first set of target resources based on the subset. For example, the first terminal device 110 may select the first set of target resources that does not comprise any resources in the subset.

FIG. 5B illustrates a schematic diagram showing an example process 520 for resource selection in accordance with some embodiments of the present disclosure. For the purpose of discussion, the example process 520 will be described with reference to FIGS. 1 and 3. However, it would be appreciated that the example process 520 may be equally applicable to other communication scenarios where a terminal device and a further terminal device communicate with each other.

Different from the example process 510, in the example process 520, the coordination information comprises information about the fourth set that comprises past resources 521, 522 and future resources 522, 523, 524, 525 and 526.

The first terminal device 110 identifies an overlap between the candidate resources 401, 402 and 403 and the resources 521, 522, 523, 524, 525 and 526 and determines a subset of the fifth set that comprises the overlap. Because there is overlap between the candidate resources 401, 402 and 403 and the resources 523, 524 and 525, a subset of the fourth set comprises the resources 523, 524 and 525. In turn, the first terminal device 110 selects the first set of target resources based on the subset. For example, the first terminal device 110 may select the first set of target resources that does not comprise any resources in the subset.

In some example embodiments, the coordination information comprises a request for the selection of the first set of target resources.

In such example embodiments, the first terminal device 110 may determine whether a priority of traffic to be transmitted exceeds a threshold priority. In some example embodiments, the threshold priority may be configured by the higher layer of the first terminal device 110.

In such example embodiments, if the priority of traffic to be transmitted exceeds the threshold priority, the first terminal device 110 may select the first set of target resources based on the request. Alternatively, if the priority of traffic to be transmitted is below the threshold priority, the first terminal device 110 may select the first set of target resources based on the request.

In such example embodiments, the first terminal device 110 may select the first set of target resources that are different from the at least one candidate resource. In other words, the first terminal device 110 may perform resource reselection for all of the at least one candidate resource.

In such example embodiments, the first terminal device 110 may receive the coordination information on a tenth resource prior to an eleventh resource among the at least one candidate resource and select a third single resource different from the eleventh resource. In other words, the first terminal device 110 may perform resource reselection only for the next candidate resource.

In some example embodiments, the first terminal device 110 may receive the coordination information on a twelfth resource after transmitting a resource reservation signaling indicating the at least one candidate resource.

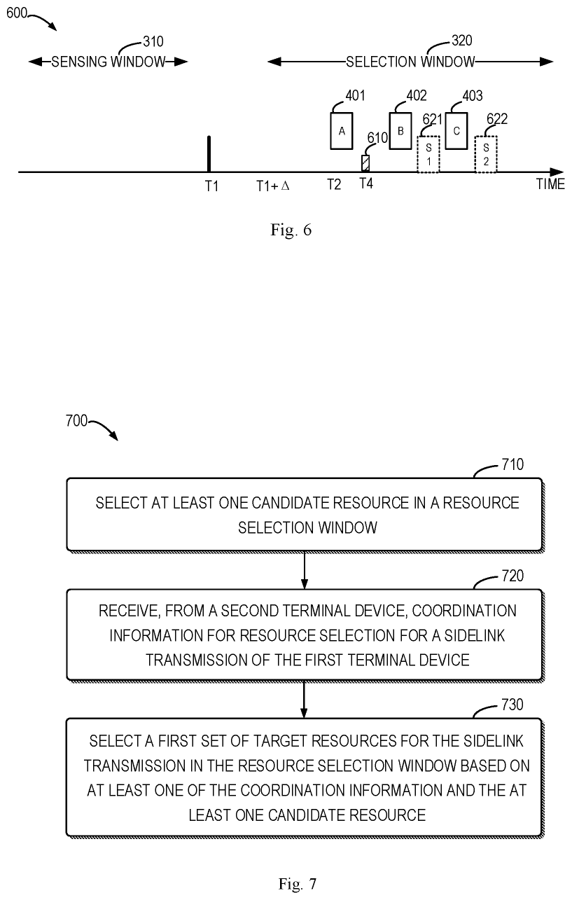

In such example embodiments, the at least one candidate resource at least comprises a thirteenth resource subsequent to the twelfth resource in time domain. If the first terminal device 110 determines that the sidelink transmission comprises transmissions of periodic traffic, the first terminal device 110 selects the first set comprising a target resource different from the thirteenth resource. In other words, the first terminal device 110 may perform resource reselection for the candidate resource that is after the timing of the resource where the coordination information is received. This will be described with reference to FIG. 6.

FIG. 6 illustrates a schematic diagram showing an example process 600 for resource selection in accordance with some embodiments of the present disclosure. For the purpose of discussion, the example process 600 will be described with reference to FIGS. 1 and 3. However, it would be appreciated that the example process 600 may be equally applicable to other communication scenarios where a terminal device and a further terminal device communicate with each other.

In the example process 600, the sidelink transmission of the first terminal device 110 comprises transmission of periodic traffic. At time T1+Δ, the first terminal device 110 selects the candidate resources 401, 402 and 403 in the resource selection window 320 for the sidelink transmission. After the time T2, that is, after transmitting the resource reservation signaling indicating the at least one candidate resource, the first terminal device 110 receives, at time T4, coordination information 610 for resource selection for the sidelink transmission. The coordination information comprises information about a set of resources that is suggested to be selected by the first terminal device 110 for the sidelink transmission. In this case, the set comprises future resources 621 and 622.

Upon receiving the coordination information, the first terminal device 110 may select the first set of target resources based on the resources 621 and 622 after the time T4. In other words, the first terminal device 110 may perform resource reselection for the candidate resource that is after the time T4. For example, the first terminal device 110 may select the resources 621 and 622 as the target resources.

It will be understood that in example embodiments where the first terminal device 110 receives the coordination information after transmitting the resource reservation signaling, the coordination information may comprise information about a single past resource, a plurality of past resources, a single future resource, or a combination of at least one past resource and at least one future resource. In these cases, the first terminal device 110 may select the first set of target resources by performing any of example processes 410-460 and 510-520.

In example embodiments where the first terminal device 110 receives the coordination information after transmitting the resource reservation signaling, if the first terminal device 110 determines that the sidelink transmission comprises the transmissions of the periodic traffic, the first terminal device 110 may reset the number of the transmissions of the periodic traffic to be an initial value selected by the first terminal device 110. For example, in the example process 600, upon resetting, the initial transmission on the reselected resource 621 corresponds to the initial transmission among the transmissions of the periodic traffic.

In some example embodiments, in order to avoid wasting the reserved resource (for example, the resources 402 and 403), the first terminal device 110 is expected to receive the coordination information w ms before transmitting the resource reservation signaling, wherein w represents time for processing the coordination information by the first terminal device 110.

In some example embodiments, in order to facilitate coordination between the first terminal device 110 and the second terminal device 120, before the second terminal device 120 transmits the coordination information to the first terminal device 110, the first terminal device 110 may transmit a request message to the second terminal device 120.

In some example embodiments, the request message may comprise at least one of the following: traffic type of the first terminal device 110, preferred coordination resource type, preferred coordination resource timing, priority of traffic of the first terminal device 110, or packet delay budget of traffic of the first terminal device 110.

In some example embodiments, the traffic type of the first terminal device 110 may indicate aperiodic traffic or periodic traffic with its periodicity.

In some example embodiments, the preferred coordination resource type may indicate suggested resource information or not suggested resource information.

In some example embodiments, the preferred coordination resource timing may indicate past resource, future resource or preferred resource timing range.

FIG. 7 illustrates a flowchart of an example method 700 in accordance with some embodiments of the present disclosure. For example, the method 700 can be performed at the first terminal device 110 as shown in FIG. 1. It is to be understood that the method 700 may include additional blocks not shown and/or may omit some blocks as shown, and the scope of the present disclosure is not limited in this regard.

At block 710, the first terminal device 110 selects at least one candidate resource in a resource selection window. At block 720, the first terminal device 110 receives, from a second terminal device, coordination information for resource selection for a sidelink transmission of the first terminal device 110. At block 730, the first terminal device 110 selects a first set of target resources for the sidelink transmission in the resource selection window based on at least one of the coordination information and the at least one candidate resource.

In some example embodiments, the first terminal device 110 may receive the coordination information after selecting the at least one candidate resource and before transmitting a resource reservation signaling indicating the at least one candidate resource.

In some example embodiments, the coordination information may comprise first information about a first single resource that is suggested to be selected by the first terminal device 110 for the sidelink transmission.

In some example embodiments, the first terminal device 110 may determine whether the sidelink transmission comprises transmissions of periodic traffic or a transmission of aperiodic traffic. If the sidelink transmission comprises transmissions of periodic traffic, the first terminal device 110 may determine a second set of available resources in the resource selection window based on the first information and a periodicity of the periodic traffic. In turn, the first terminal device 110 may select the first set of target resources based on the second set of available resources.

In some example embodiments, the first terminal device 110 may select the first set of target resources based on the second set of available resources by iteratively performing the following until a first number of the target resources in the first set is equal to a first predetermined number. The first terminal device 110 may select a starting target resource in the first set based on a first available resource in the second set. In turn, the first terminal device 110 may update the starting target resource with a target resource subsequent to the starting target resource in the first set and update the first available resource with an available resource subsequent to the first available resource in the second set.

In some example embodiments, the first available resource in the second set may comprise a starting available resource in the second set.

Alternatively or additionally, the first available resource in the second set may comprise a second available resource in the second set that is subsequent to the starting target resource in time domain.

Alternatively or additionally, the first available resource in the second set may comprise a third available resource in the second set. A timing value between the third available resource and a starting candidate resource among the at least one candidate resource is equal to a first threshold timing value.

In some example embodiments, the first terminal device 110 may receive the coordination information on a resource subsequent to the first single resource in time domain, the second set excluding the first single resource.

In some example embodiments, the first terminal device 110 may receive the coordination information on a resource prior to the first single resource in time domain, the second set including the first single resource.

In some example embodiments, the first terminal device 110 may determine whether the sidelink transmission comprises transmissions of periodic traffic or a transmission of aperiodic traffic. If the sidelink transmission comprises the transmission of aperiodic traffic, the first terminal device 110 may select the first set of target resources based on the first single resource. The first set of target resources comprises a second single target resource.

In some example embodiments, the coordination information comprises second information about a third set of resources that are suggested to be selected by the first terminal device 110 for the sidelink transmission. The third set comprises a plurality of resources.

In some example embodiments, the first terminal device 110 may receive the coordination information on a resource prior to a starting resource in the third set in time domain.

In some example embodiments, the first terminal device 110 may determine whether the sidelink transmission comprises transmissions of periodic traffic or a transmission of aperiodic traffic. If the sidelink transmission comprises transmissions of periodic traffic, the first terminal device 110 may determine whether a first periodicity of the plurality of resources in the third set is equal to a second periodicity of the periodic traffic. If the first periodicity is equal to the second periodicity, the first terminal device 110 may select the first set of target resources based on the third set.

In some example embodiments, the first terminal device 110 may receive the coordination information on a resource subsequent to a starting resource in the third set in time domain. In such example embodiments, a subset of the third set is in the resource selection window.

In some example embodiments, the first terminal device 110 may determine whether the sidelink transmission comprises transmissions of periodic traffic or a transmission of aperiodic traffic. If the sidelink transmission comprises the transmission of aperiodic traffic, the first terminal device 110 may select the first set of target resources based on a fourth resource in the subset.

In some example embodiments, the fourth resource may comprise a starting resource in the subset.

Alternatively or additionally, the fourth resource may comprise a fifth resource in the subset that is subsequent to a starting target resource in the first set in time domain.

Alternatively or additionally, the fourth resource may comprise a sixth resource in the subset. A timing value between the sixth resource and a starting candidate resource among the at least one candidate resource is equal to a second threshold timing value.

In some example embodiments, the first terminal device 110 may determine whether the sidelink transmission comprises transmissions of periodic traffic or a transmission of aperiodic traffic. If the sidelink transmission comprises transmissions of periodic traffic, the first terminal device 110 may select the first set by iteratively performing the following until a second number of the target resources in the first set is equal to a second predetermined number. The first terminal device 110 may select a starting target resource in the first set based on a seventh resource in the subset. Further, the first terminal device 110 may update the starting target resource with a target resource subsequent to the starting target resource in the first set and update the seventh resource with a resource subsequent to the seventh available resource in the subset.

In some example embodiments, the seventh resource in the subset may comprise a starting resource in the subset.

Alternatively or additionally, the seventh resource in the subset may comprise an eighth resource in the subset that is subsequent to the starting target resource in time domain.

Alternatively or additionally, the seventh resource in the subset may comprise a ninth resource in the subset. A timing value between the ninth resource and a starting candidate resource among the at least one candidate resource is equal to a third threshold timing value.

In some example embodiments, the coordination information may comprise third information about a fourth set of resources that are not suggested to be selected by the first terminal device 110 for the sidelink transmission.

In some example embodiments, the first terminal device 110 may identify an overlap between the at least one candidate resource and the fourth set and determine a subset of the fourth set that comprises the overlap. In turn, the first terminal device 110 may select the first set based on the subset.

In some example embodiments, the coordination information comprises a request for the selection of the first set of target resources.

In some example embodiments, the first terminal device 110 may determine whether a priority of traffic to be transmitted exceeds a threshold priority. If the priority of traffic to be transmitted exceeds the threshold priority, the first terminal device 110 may select the first set of target resources based on the request.

In some example embodiments, the first terminal device 110 may select the first set that comprises at least one target resource different from each of the at least one candidate resource.

In some example embodiments, the first terminal device 110 may receive the coordination information on a tenth resource prior to an eleventh resource among the at least one candidate resource. In such example embodiments, the first terminal device 110 may select a third single resource different from the eleventh resource.

In some example embodiments, the first terminal device 110 may receive the coordination information on a twelfth resource after transmitting a resource reservation signaling indicating the at least one candidate resource.

In some example embodiments, the at least one candidate resource at least comprises a thirteenth resource subsequent to the twelfth resource in time domain. In such example embodiments, the first terminal device 110 may determine whether the sidelink transmission comprises transmissions of periodic traffic or a transmission of aperiodic traffic. If the sidelink transmission comprises transmissions of periodic traffic, the first terminal device 110 may select the first set comprising a target resource different from the thirteenth resource.

Additionally, in some example embodiments, if the sidelink transmission comprises transmissions of periodic traffic, the first terminal device 110 may reset the number of the transmissions of the periodic traffic to be an initial value selected by the first terminal device 110.

FIG. 8 illustrates a flowchart of an example method 800 in accordance with some embodiments of the present disclosure. For example, the method 800 can be performed at the first terminal device 110 as shown in FIG. 1. It is to be understood that the method 800 may include additional blocks not shown and/or may omit some blocks as shown, and the scope of the present disclosure is not limited in this regard.

At block 810, the first terminal device 110 selects at least one candidate resource in a resource selection window. At block 820, the first terminal device 110 receives, from a second terminal device, information for resource selection for a sidelink transmission of the first terminal device 110. At block 830, the first terminal device 110 determines at least one target resource for the sidelink transmission in the resource selection window based on at least one of the information and the at least one candidate resource.

In some example embodiments, the information received by the first terminal device 110 may comprise the coordination information for the resource selection, as described with reference to FIGS. 1-7.

In other example embodiments, the information received by the first terminal device 110 may comprise assistance information for the resource selection. For example, the assistance information may comprise the request for the selection of the at least one target resource, as described with reference to FIGS. 1-7. For another example, the assistance information may comprise a trigger or indication for the selection of the at least one target resource.

It should be understood that features as described with reference to FIGS. 1-7 are also applicable to the method 800. For the purpose of brevity, details of the features are omitted.

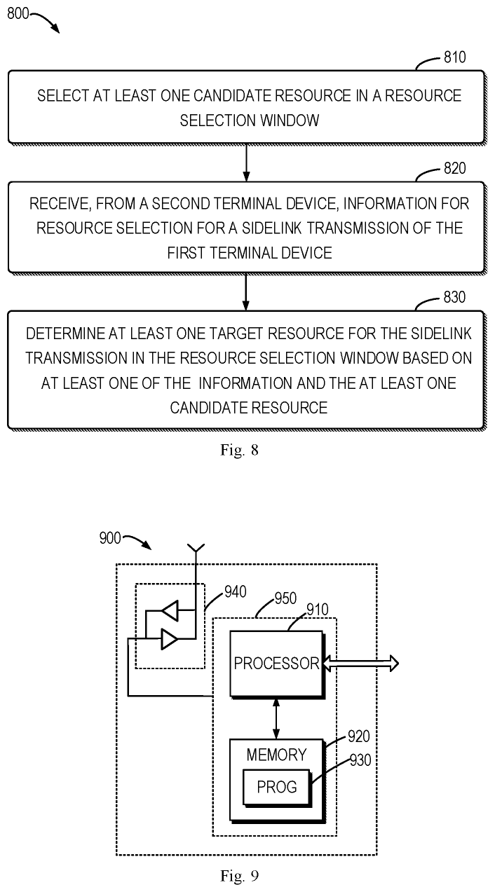

FIG. 9 is a simplified block diagram of a device 900 that is suitable for implementing embodiments of the present disclosure. The device 900 can be considered as a further example implementation of the terminal device 110 or 120 as shown in FIG. 1. Accordingly, the device 900 can be implemented at or as at least a part of the terminal device 110 or 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 930 is assumed to include program instructions that, when executed by the associated processor 910, enable the device 900 to operate in accordance with the embodiments of the present disclosure, as discussed herein with reference to FIGS. 1 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote readable media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communications, comprising:
selecting, at a first terminal device, at least one candidate resource in a resource selection window;
receiving, from a second terminal device, coordination information for resource selection for a sidelink transmission of the first terminal device; and
selecting a first set of target resources for the sidelink transmission in the resource selection window based on at least one of the coordination information and the at least one candidate resource.

2. The method of claim 1, wherein receiving the coordination information comprises:
receiving the coordination information after selecting the at least one candidate resource and before transmitting a resource reservation signaling indicating the at least one candidate resource.

3. The method of claim 2, wherein the coordination information comprises first information about a first single resource that is suggested to be selected by the first terminal device for the sidelink transmission.

4. The method of claim 3, wherein selecting the first set of target resources comprises:
in accordance with a determination that the sidelink transmission comprises transmissions of periodic traffic, determining a second set of available resources in the resource selection window based on the first information and a periodicity of the periodic traffic; and
selecting the first set of target resources based on the second set of available resources.

5. The method of claim 4, wherein selecting the first set of target resources based on the second set of available resources comprises:
iteratively performing the following until a first number of the target resources in the first set is equal to a first predetermined number:
selecting a starting target resource in the first set based on a first available resource in the second set;
updating the starting target resource with a target resource subsequent to the starting target resource in the first set; and
updating the first available resource with an available resource subsequent to the first available resource in the second set.

6. The method of claim 5, wherein the first available resource in the second set comprises at least one of the following:
a starting available resource in the second set,
a second available resource in the second set that is subsequent to the starting target resource in time domain, or
a third available resource in the second set, a timing value between the third available resource and a starting candidate resource among the at least one candidate resource being equal to a first threshold timing value.

7. The method of claim 4, wherein receiving the coordination information comprises:
receiving the coordination information on a resource subsequent to the first single resource in time domain, the second set excluding the first single resource.

8. The method of claim 4, wherein receiving the coordination information comprises:
receiving the coordination information on a resource prior to the first single resource in time domain, the second set including the first single resource.

9. The method of claim 3, wherein selecting the first set of target resources comprises:
in accordance with a determination that the sidelink transmission comprises a transmission of aperiodic traffic, selecting the first set of target resources based on the first single resource, the first set of target resources comprising a second single target resource.

10. The method of claim 2, wherein the coordination information comprises second information about a third set of resources that are suggested to be selected by the first terminal device for the sidelink transmission, the third set comprising a plurality of resources.

11. The method of claim 10, wherein receiving the coordination information comprises:
receiving the coordination information on a resource prior to a starting resource in the third set in time domain.

12. The method of claim 11, wherein selecting the first set of target resources comprises:
in accordance with a determination that the sidelink transmission comprises transmissions of periodic traffic, determining whether a first periodicity of the plurality of resources in the third set is equal to a second periodicity of the periodic traffic; and
in accordance with a determination that the first periodicity is equal to the second periodicity, selecting the first set of target resources based on the third set.

13. The method of claim 10, wherein receiving the coordination information comprises:
receiving the coordination information on a resource subsequent to a starting resource in the third set in time domain; and
wherein a subset of the third set is in the resource selection window.

14. The method of claim 13, wherein selecting the first set of target resources comprises:
in accordance with a determination that the sidelink transmission comprises a transmission of aperiodic traffic, selecting the first set of target resources based on a fourth resource in the subset, and the fourth resource comprises at least one of the following:
a starting resource in the subset,
a fifth resource in the subset that is subsequent to a starting target resource in the first set in time domain, or
a sixth resource in the subset, a timing value between the sixth resource and a starting candidate resource among the at least one candidate resource being equal to a second threshold timing value.

15. The method of claim 13, wherein selecting the first set of target resources comprises:
in accordance with a determination that the sidelink transmission comprises transmissions of periodic traffic, selecting the first set by iteratively performing the following until a second number of the target resources in the first set is equal to a second predetermined number:
selecting a starting target resource in the first set based on a seventh resource in the subset;
updating the starting target resource with a target resource subsequent to the starting target resource in the first set; and
updating the seventh resource with a resource subsequent to the seventh available resource in the subset.

16. The method of claim 15, wherein the seventh resource in the subset comprises at least one of the following:
a starting resource in the subset,
an eighth resource in the subset that is subsequent to the starting target resource in time domain, or
a ninth resource in the subset, a timing value between the ninth resource and a starting candidate resource among the at least one candidate resource being equal to a third threshold timing value.

17. The method of claim 2, wherein the coordination information comprises third information about a fourth set of resources that are not suggested to be selected by the first terminal device for the sidelink transmission.

18. The method of claim 17, wherein selecting the first set of target resources comprises:
identifying an overlap between the at least one candidate resource and the fourth set;
determining a subset of the fourth set that comprises the overlap; and
selecting the first set based on the subset.

19. The method of claim 2, wherein the coordination information comprises a request for the selection of the first set of target resources.

20. The method of claim 19, wherein selecting the first set of target resources comprises:
in accordance with a determination that a priority of traffic to be transmitted exceeds a threshold priority, selecting the first set of target resources based on the request.

21. The method of claim 19, wherein selecting the first set of target resources comprises:
selecting the first set that comprises at least one target resource different from each of the at least one candidate resource.

22. The method of claim 19, wherein receiving the coordination information comprises:
receiving the coordination information on a tenth resource prior to an eleventh resource among the at least one candidate resource; and
wherein selecting the first set of target resources comprises:
selecting a third single resource different from the eleventh resource.

23. The method of claim 1, wherein receiving the coordination information comprises:
receiving the coordination information on a twelfth resource after transmitting a resource reservation signaling indicating the at least one candidate resource.

24. The method of claim 23, wherein the at least one candidate resource at least comprises a thirteenth resource subsequent to the twelfth resource in time domain; and
wherein selecting the first set of target resources comprises:
in accordance with a determination that the sidelink transmission comprises transmissions of periodic traffic, selecting the first set comprising a target resource different from the thirteenth resource.

25. The method of claim 24, further comprising:
in accordance with a determination that the sidelink transmission comprises the transmissions of the periodic traffic, resetting the number of the transmissions of the periodic traffic to be an initial value selected by the first terminal device.

26. A method for communications, comprising:
selecting, at a first terminal device, at least one candidate resource in a resource selection window;
receiving, from a second terminal device, information for resource selection for a sidelink transmission of the first terminal device; and
determining at least one target resource for the sidelink transmission in the resource selection window based on at least one of the information and the at least one candidate resource.

27. A terminal device, comprising:
a processor; and
a memory coupled to the processor and storing instructions thereon, the instructions, when executed by the processor, causing the terminal device to perform the method according to any of claims 1-26.

28. A computer readable medium having instructions stored thereon, the instructions, when executed on at least one processor of a device, causing the device to carry out the method according to any of claims 1-26.
